(19) United States
(12) Patent Application Publication
(10) Pub. No.: US 2025/0181873 A1
(43) Pub. Date: Jun. 5, 2025

(54) BIOMETRIC SMARTCARD WITH VOLTAGE CONVERTER AND METHOD FOR MANUFACTURING THE SMARTCARD

(71) Applicant: FINGERPRINT CARDS ANACATUM IP AB, GÖTEBORG (SE)

(72) Inventor: Johan Hammersberg, Floda (SE)

(21) Appl. No.: 18/845,147

(22) PCT Filed: Mar. 22, 2023
(86) PCT No.: PCT/SE2023/050249

§ 371 Date: Sep. 9, 2024

(30) Foreign Application Priority Data
Mar. 28, 2022 (SE) 2250383-3

(51) Int. Cl. G06K 19/07; H02M 3/00; H02M 3/156

(52) U.S. Cl. CPC G06K 19/0718; H02M 3/003; H02M 3/156

(57) ABSTRACT

A smartcard comprising: a fingerprint sensor module; a microcontroller module; a contact plate comprising externally accessible contacts configured to communicate with a terminal, the contact plate being galvanically connected to the microcontroller module; and an inductive voltage boost converter comprising an inductor arranged in series with a diode and a switch configured to selectively connect a point between the inductor and the diode to ground, wherein the inductor is an inductive coil in at least one conductive layer of the smartcard and wherein the diode and the switch are arranged in an integrated circuit module located in the smartcard and connected to the inductor

### FIELD OF THE INVENTION

The present invention relates to a smartcard comprising a fingerprint sensor module. In particular, the invention relates to the power supply of a fingerprint sensor module in a smartcard.

### BACKGROUND OF THE INVENTION

As the development of biometric devices for identity verification, and in particular of fingerprint sensing devices, has led to devices which are made smaller, cheaper and more energy efficient, the range of applications for such devices is increasing.

In particular, capacitive fingerprint sensing devices have been adopted more and more in for example consumer electronic devices due to small form factor, relatively beneficial cost/performance factor and high user acceptance. There is also an increasing interest in using fingerprint sensors in smartcards to enable biometric identification in a card such as a bank card where other types of biometric systems are not applicable.

The integration of fingerprint sensors in smartcards and the like puts new requirements on the fingerprint sensor module for example in terms of energy consumption and wear resistance. Moreover, a smartcard often contains a contact plate for physically connecting the card to a terminal as well as a wireless interface for contactless operation.

Furthermore, in order to be able to operate a biometric smartcard in a wireless mode, the smartcard must receive sufficient power to drive the fingerprint sensor module.

In contactless cards such as the described smartcard, an inductor is commonly integrated in the card to receive power from a transmitter. However, the amount of power which can be transmitted is limited and with increasing functionality in a smartcard, new solutions may be needed to provide the current and voltage required by components in the smartcard.

Accordingly, it is desirable to improve the wireless power supply for a smartcard comprising a biometric sensor.

### SUMMARY

In view of above-mentioned and other drawbacks of the prior art, it is an object of the present invention to provide a smartcard having improved power supply circuitry and a method for manufacturing such a smartcard.

According to a first aspect of the invention, it is provided a smartcard comprising: a fingerprint sensor module; a microcontroller module; a contact plate comprising externally accessible contacts configured to communicate with a terminal, the contact plate being galvanically connected to the microcontroller module; and an inductive voltage boost converter comprising an inductor arranged in series with a diode and a switch configured to selectively connect a point between the inductor and the diode to ground, wherein the inductor is formed as an inductive coil in at least one conductive layer of the smartcard and wherein the diode and the switch are arranged in an integrated circuit module located in the smartcard and connected to the inductor.

A smartcard can be considered to be any card comprising functionality such as biometric sensing, and smartcards may be used as payment cards, identification cards, access cards and in other applications where a card with built-in functionality is desirable. In the present context, the smartcard comprises a fingerprint sensor module and a microcontroller module. The microcontroller module is configured to at least control communication between the smartcard and a reader terminal, and the microcontroller module may also comprise functionality related to fingerprint acquisition by the fingerprint sensor module.

The fingerprint sensor module comprises at least a fingerprint sensor having an active sensing surface, and the fingerprint sensor may advantageously be a capacitive fingerprint sensor comprising an array of electrically conductive sensing elements. A capacitive fingerprint sensor should be understood to further comprise sensing circuitry connected to sensing elements for reading a signal from the sensing elements. The sensing circuitry may in turn comprise or be connected to readout circuitry for providing a result of the sensing elements to an external device for further processing, which in the present case may be included in the fingerprint sensor module. The fingerprint sensor module may also comprise additional passive or active components.

The smartcard contains a contact plate for physically connecting the smartcard to a reader terminal to thereby provide a wired connection option in addition to wireless/contactless communication.

The present invention is based on the realization that an inductive voltage boost converter can be implemented in a smartcard by forming the inductor of the voltage boost converter as an inductive coil in a conductive layer of the smartcard. An inductor in the form of a discrete component having a sufficiently high inductance to be useful in a voltage boost converter would risk being too bulky to be embedded in a smartcard. Accordingly, the claimed invention overcomes the problem of using a bulky discrete component and is thereby capable of providing a higher voltage for components on the smartcard than what would be possible otherwise.

Moreover, since diodes and switches can be easily integrated in for example silicon-based circuitry of the fingerprint sensor module and/or of the microcontroller, it is sufficient that the inductor of the voltage boost converter is arranged in a conductive layer of the smartcard where it can be connected to the remaining components.

According to one embodiment of the invention the inductive voltage boost converter further comprises at least one capacitor arranged as a discrete component in the smartcard. The voltage boost converter comprises at least a capacitor arranged between an output terminal and ground, and the capacitor can be arranged as a discrete component which can be surface mounted to the smartcard and/or to the fingerprint sensor module or microcontroller module of the smart card. The voltage boost converter may further comprise an additional capacitor arranged between an input terminal and ground and this capacitor may also be a discrete component.

According to one embodiment of the invention, the inductive voltage boost converter further comprises at least one capacitor formed as a plate capacitor having a first plate in a first conductive layer of the smartcard and a second plate in a second conductive layer of the smartcard. By arranging the capacitor formed as a plate capacitor in the smartcard the need of discrete components for the voltage boost converter can be eliminated, which in turn can simplify manufacturing of the smartcard.

According to one embodiment of the invention, the inductor comprises a first coil arranged in a first conductive layer of the smartcard and a second coil arranged in a second conductive layer of the smartcard, the first conductive layer being separated from the second conductive layer by an insulating layer, and wherein a connection between the first coil and the second coil is formed through the insulating layer. Accordingly, twice the area of the smartcard can then be utilized to form inductive coils, and the total inductance of the inductor can thereby be increased by connecting two or more coils in series. In principle, the concept can be extended by increasing the number of conductive layers in the smartcard, where each conductive layer can comprise one or more coils forming part of the inductor.

According to one embodiment of the invention, the inductor is formed by an isolated conductive wire arranged as a coil in a layer of the smartcard. By using an insulated conductive wire such as a copper wire, the wire is allowed to overlap making it possible to form a connection to both ends of the coil in a single conductive layer.

According to one embodiment of the invention, the inductor may be formed by a conductive foil arranged as a coil in a conductive layer of the smartcard. A via-connection from another layer can then be used to connect the inner end of the inductive coil to the remaining circuitry.

According to one embodiment of the invention, the integrated circuit module comprising the diode and the switch of the inductive voltage boost converter is the fingerprint sensor module. This makes it possible to implement the described voltage boost converter without adding any integrated circuit.

According to one embodiment of the invention, the integrated circuit module comprising the diode and the switch of the inductive voltage boost converter is the microcontroller module. Moreover, the diode and the switch of the inductive voltage boost converter may also be arranged in a readout circuitry module connected to the fingerprint sensor module.

According to one embodiment of the invention, the fingerprint sensor module comprises a capacitive fingerprint sensing device having capacitive sensing circuitry formed by thin-film-transistors, TFT. A TFT-based fingerprint sensor module requires higher drive voltages compared to a conventional silicon-based capacitive fingerprint sensor module, such as voltages of 10V or more. The required voltage can be provided by using the described inductive voltage boost converter, thereby making it possible to integrate TFT-based fingerprint sensor modules in smartcards.

According to a second aspect of the invention, there is provided a method of manufacturing a smartcard The method comprises: providing a smartcard substrate; forming an inductor of an inductive voltage boost converter as an inductive coil in a conductive layer of the smartcard; arranging a fingerprint sensor module, a microcontroller module and a contact plate in the smartcard, wherein one of the fingerprint sensor module and the microcontroller module comprises a diode and a switch of an inductive voltage boost converter; and forming an electrical connection between the inductor, the diode and the switch of the inductive voltage boost converter.

Additional effects and features of the second aspect of the invention are largely analogous to those described above in connection with the first aspect of the invention.

Further features of, and advantages with, the present invention will become apparent when studying the appended claims and the following description. The skilled person realize that different features of the present invention may be combined to create embodiments other than those described in the following, without departing from the scope of the present invention.

### BRIEF DESCRIPTION OF THE DRAWINGS

These and other aspects of the present invention will now be described in more detail, with reference to the appended drawings showing an example embodiment of the invention, wherein:

FIG. 1 schematically illustrates a card reader and a smartcard comprising a fingerprint sensor module according to an embodiment of the invention;

FIG. 2 is a circuit schematic illustrating a circuit comprised in a smartcard according to an embodiment of the invention;

FIGS. 3A-B schematically illustrates a smartcard according to an embodiment of the invention;

FIGS. 4A-B schematically illustrates a smartcard according to an embodiment of the invention;

FIG. 5 is a flowchart outlining steps of a method of manufacturing a smartcard according to an embodiment of the invention; and

FIGS. 6A-D schematically illustrate steps of a method of manufacturing a smartcard according to an embodiment of the invention.

### DETAILED DESCRIPTION OF EXAMPLE EMBODIMENTS

In the present detailed description, various embodiments of the system and method according to the present invention are mainly described with reference to a smartcard comprising a capacitive fingerprint sensor module. However, the described smartcard comprising an inductive voltage boost converter may also be used with other types of biometric sensors and/or components where a high voltage is required.

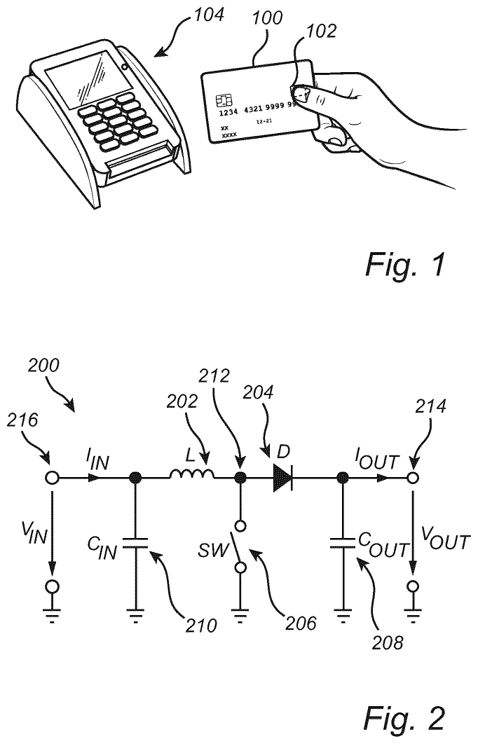

FIG. 1 schematically illustrates a smartcard 100 comprising a fingerprint sensor module 102 according to an embodiment of the invention. The smartcard 100 is provided with means for wireless communication with a smartcard reader such as a point-of-sale (POS) terminal 104.

FIG. 2 is a circuit schematic illustrating an inductive voltage boost circuit 200 comprised in the smartcard 100. The voltage boost circuit 200 comprises an inductor 202 arranged in series with a diode 204 and a switch 206 configured to selectively connect a point 212 between the inductor 202 and the diode 204 to ground potential. The circuit further comprises two capacitors 208, 210, an output capacitor 208 connected between an output terminal 214 and ground and an input capacitor 210 connected between an input terminal 216 and ground. The general functionality of the voltage boost converter 200 is to receive a DC-voltage on the input terminal 216 and by cycling the switch 206, providing a higher voltage on the output terminal 214. The input capacitor 210 acts to even out and filter the load current of the voltage boost converter 200. Each of the input capacitor 210 and the output capacitor 208 can be formed as plate capacitors in conductive layers of the smartcard. An inductive voltage boost converter is a well-known circuit as such, and the functionality will not be described in further detail herein.

The input voltage can be provided by a conventional RFID-antenna embedded in the card and depending on the distance between the smartcard 100 and the reader terminal, the input voltage can be in the range of 1V-10V. The RFID circuitry of the smartcard commonly comprise a low-dropout regulator (LDO regulator) which regulates the output voltage to e.g. 1.8V, which then becomes the input voltage of the inductive voltage boost converter 200. The inductive voltage boost converter 200 is preferably configured to convert an input voltage of 1.8V to an output voltage in the range of 10V to 15V.

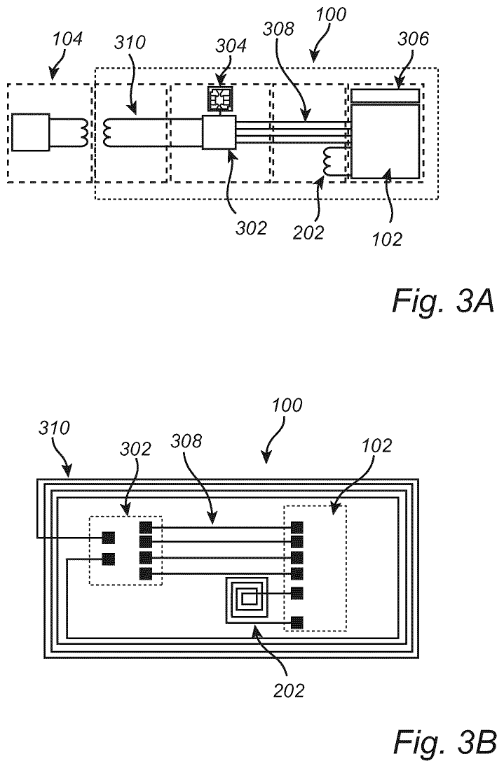

FIGS. 3A-B schematically illustrate a smartcard 100 according to an embodiment of the invention where FIG. 3A is a circuit schematic describing components of the smartcard 100 and FIG. 3B is an exemplary illustration of how an electrically conductive inlay of the smartcard 100 can be configured to achieve the described functionality.

The smartcard 100 can be considered to be formed as a laminate structure comprising a plurality of layers, such as one or more core layers and outer layers on respective sides of the core layer(s). Typically, the smartcard 100 will also comprise one or more electrically conductive layers embedded in the smartcard 100 to route signals between different parts of the card and to form antennas for power harvesting and communication. An electrically conductive layer can also be referred to as a conductive inlay.

With reference to FIGS. 3A-B, the smartcard 100 comprises a fingerprint sensor module 102, a microcontroller module 302 and a contact plate 304 comprising externally accessible contacts configured to communicate with an external reader terminal 104, the contact plate 304 is galvanically connected to the microcontroller module.

The contact plate 304 may be of the type commonly used in credit cards having contact pads configured according to ISO/IEC 7816-2. The contact plate 304, contact pads and/or the contact area may also be referred to as an “ISO-plate”.

In addition to controlling communication via the contact plate 304, the microcontroller module 302 may further comprise a secure element, SE, used in fingerprint authentication and the microcontroller module 302 may also be configured to control communication with and/or operation of the fingerprint sensor module 102. Thereby, there is no need for a separate secure element or for a specific controller for the fingerprint sensor module 102. However, some of the described functionality may equally well be integrated in the fingerprint sensor module 102 or be provided as separate modules.

Moreover, the microcontroller module 302 may include a microprocessor, microcontroller, programmable digital signal processor or another programmable device. The control unit may also, or instead, include an application specific integrated circuit, a programmable gate array or programmable array logic, a programmable logic device, or a digital signal processor. Where the microcontroller module 302 includes a programmable device such as the microprocessor, microcontroller or programmable digital signal processor mentioned above, the processor may further include computer executable code that controls operation of the programmable device.

The smartcard is also illustrated to comprise one or more surface mounted devices (SMD) 306 such as capacitors and/or resistors.

The smartcard 100 further comprises an inductive voltage boost converter 200 as illustrated in FIG. 2. The voltage boost converter 200 comprises an inductor 202 in the form of an inductive coil arranged in at least one conductive layer of the smartcard and wherein the diode 204 and the switch 206 are arranged in an integrated circuit module 102 located in the smartcard and connected to the inductor 202. Here, the diode 204 and the switch 206 are integrated in the fingerprint sensor module 102.

In the example illustrated in FIGS. 3A-B, the inductor 202 is arranged in a single conductive layer of the smartcard, and the diode 204 and switch 206 are arranged in the fingerprint sensor module 102. The conductive paths of the conductive layer can be formed by isolated copper wires which makes it possible to cross wires in the same conductive layer. The conductive wires are also used to form connections 308 between the fingerprint sensor module 102 and the microcontroller module 302. Moreover, the smartcard 100 comprises an antenna 310 for communication with the reader terminal 104 and for energy harvesting.

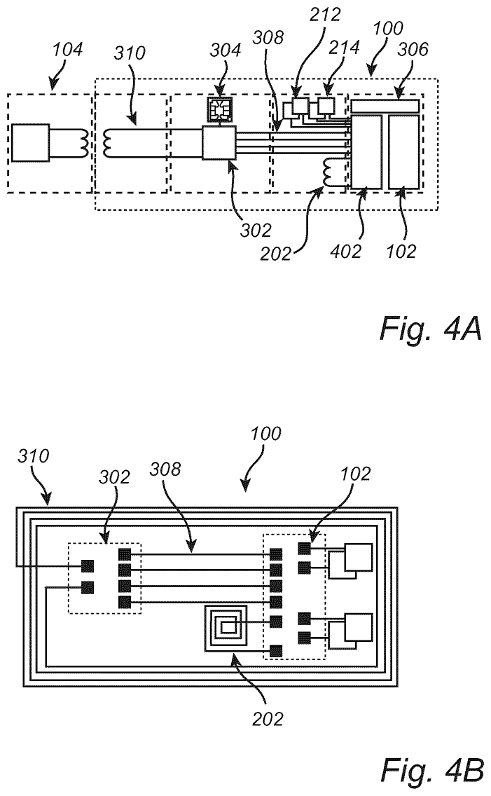

FIGS. 4A-B, schematically illustrate a smartcard 100 comprising capacitors 212, 214 formed as a parallel plate capacitors 212, 214 having a respective first plate in a first conductive layer of the smartcard and a second plate in a second conductive layer of the smartcard. In FIG. 4B the capacitive plates are shown with a slight offset in relation to each other for purely illustrative purposes. To form the capacitors 212, 214, two conductive layers of the smartcard are used where each conductive layer comprises aluminum foils forming the desired conductive pattern. However, it would also be possible to form the capacitors using isolated conductive wires by arranging the wires in a meandering pattern in two separate conductive layers. Moreover, when a conductive foil is used to form the inductor 202, a via connection is required for electrically connecting the inside end of the inductive coil.

FIG. 4A further illustrates an embodiment of the smartcard 100 where fingerprint sensor readout circuitry 402 is arranged separately from the fingerprint sensor module 102 and where the diode 204 and switch 206 are arranged in the readout circuitry 402. In applications where the fingerprint sensor module 102 and the associated readout circuitry are manufactured using different technologies, it may be preferable to form the readout circuitry 402 separately from the fingerprint sensor module 102. An example is when the readout circuitry 402 is silicon-based and where the fingerprint sensor comprises a TFT-matrix. However, the readout circuitry 402 and the fingerprint sensor module 102 are preferably arranged in the same package to facilitate assembly of the smartcard.

The described embodiments of a smartcard are advantageously used with a fingerprint sensor module having a TFT-based sensor matrix. However, the described smartcard and inductive voltage boost converter can be used with any component requiring a high voltage, where a high voltage in the present context may be a voltage in the range of 10V to 15V.

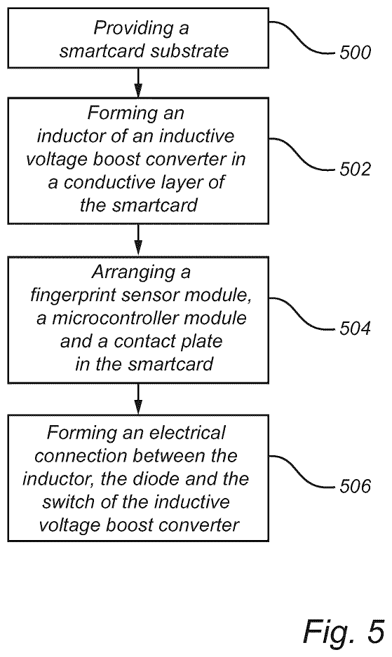

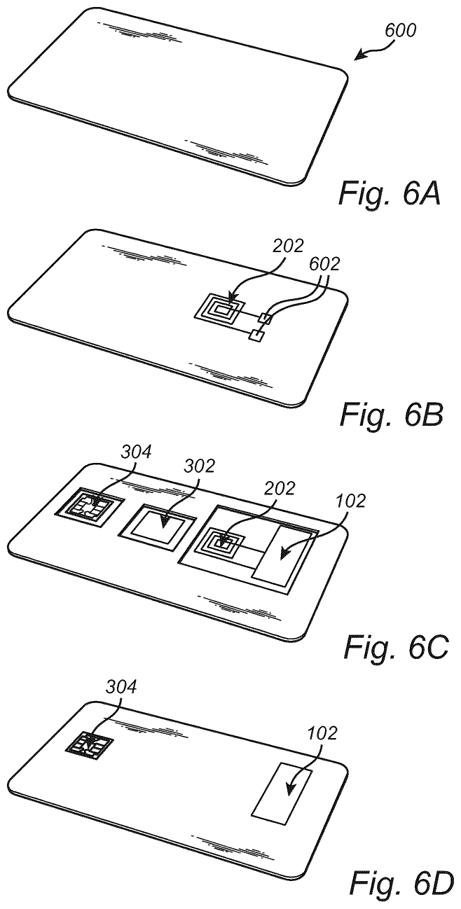

FIG. 5 is a flowchart outlining steps of a method of manufacturing a smartcard 100 according to an embodiment of the invention the method will be described with further reference to FIG. 6 schematically illustrating steps of the method.

First, the method comprises providing 500 a smartcard substrate 600 as illustrated in FIG. 6A. The smartcard substrate 600 may be a single layer substrate or it may consist of a plurality of layers.

Next, illustrated in FIG. 6B, an inductor 202 of an inductive voltage boost converter 200 is formed in a conductive layer of the smartcard 100 as a coil of either an insulated conductive wire or of a conductive foil. Contact pads 602 for connecting the inductor to the associated circuitry are formed in the same process step as the formation of the inductor. Additional conductive structures such as routing wires and contact pads are also typically formed in the same step but are not included in the figures to avoid cluttering the drawings. The step of providing aa conductive layer may be repeated if it desirable to form additional coils in other conductive layers of the smartcard. Conductive layers are then separated by an insulating layer.

Furthermore, the method comprises arranging 504 a fingerprint sensor module 102, a microcontroller module 302 and a contact plate 304 in the smartcard which is illustrated in FIG. 6C. Any one of the fingerprint sensor module 102 and the microcontroller module 202 may comprise the diode 204 and the switch 206 of the inductive voltage boost converter 200. The fingerprint sensor module 102, microcontroller module 302 and the contact plate 304 are arranged in openings of the smartcard substrate 600 or in openings of an intermediate layer arranged on the substrate 600. It may also be possible to first arrange one or more of the modules on the smartcard followed by arranging one or more smartcard layers having corresponding cutouts for the modules so that a substantially flat surface of the smartcard is achieved.

The next step comprises forming 506 an electrical connection between the inductor 202, the diode 204 and the switch 206 of the inductive voltage boost converter 200, which here entails forming an electrical connection between the inductor 202 and the fingerprint sensor module 102 by arranging the fingerprint sensor module 102 so that connection pads of the fingerprint sensor module 102 contact the connection pads 602 of the inductor 202.

In a final step, an outer layer of the smartcard is provided so that the smartcard 100 is ready for use as illustrated in FIG. 6D. It should be noted that the order of the described steps may be modified. It may for example be possible to arrange the fingerprint sensor module and other modules in the smartcard before forming the inductor.

Even though the invention has been described with reference to specific exemplifying embodiments thereof, many different alterations, modifications and the like will become apparent for those skilled in the art. Also, it should be noted that parts of the smartcard may be omitted, interchanged or arranged in various ways, the smartcard yet being able to perform the functionality of the present invention.

Additionally, variations to the disclosed embodiments can be understood and effected by the skilled person in practicing the claimed invention, from a study of the drawings, the disclosure, and the appended claims. In the claims, the word “comprising” does not exclude other elements or steps, and the indefinite article “a” or “an” does not exclude a plurality. The mere fact that certain measures are recited in mutually different dependent claims does not indicate that a combination of these measures cannot be used to advantage.

1. A smartcard comprising:
a fingerprint sensor module;
a microcontroller module;
a contact plate comprising externally accessible contacts configured to communicate with a terminal, the contact plate being galvanically connected to the microcontroller module; and
an inductive voltage boost converter comprising an inductor arranged in series with a diode and a switch configured to selectively connect a point between the inductor and the diode to ground,
wherein the inductor is formed as an inductive coil in at least one conductive layer of the smartcard and wherein the diode and the switch are arranged in an integrated circuit module located in the smartcard and connected to the inductor.

2. The smartcard according to claim 1, wherein the inductive voltage boost converter further comprises at least one capacitor arranged as a discrete component in the smartcard.

3. The smartcard according to claim 1, wherein the inductive voltage boost converter further comprises at least one capacitor formed as a plate capacitor having a first plate in a first conductive layer of the smartcard and a second plate in a second conductive layer of the smartcard.

4. The smartcard according to claim 1, wherein the inductor comprises a first coil arranged in a first conductive layer of the smartcard and a second coil arranged in a second conductive layer of the smartcard, the first conductive layer being separated from the second conductive layer by an insulating layer, and wherein a connection between the first coil and the second coil is formed through the insulating layer.

5. The smartcard according to claim 1, wherein the inductor is formed by an isolated conductive wire arranged as a coil in a layer of the smartcard.

6. The smartcard according to claim 1, wherein the inductor is formed by a conductive foil arranged as a coil in a conductive layer of the smartcard.

7. The smartcard according to claim 1, wherein the integrated circuit module comprising the diode and the switch of the inductive voltage boost converter is the fingerprint sensor module.

8. The smartcard according to claim 1, wherein the integrated circuit module comprising the diode and the switch of the inductive voltage boost converter is the microcontroller module.

9. The smartcard according to claim 1, wherein the integrated circuit module comprising the diode and the switch of the inductive voltage boost converter is a readout circuitry module connected to the fingerprint sensor module.

10. The smartcard according to claim 1, wherein the fingerprint sensor module comprises a capacitive fingerprint sensing device having capacitive sensing circuitry formed by thin-film-transistors, TFT.

11. Method of manufacturing a smartcard, the method comprising:
providing a smartcard substrate;
forming an inductor of an inductive voltage boost converter as an inductive coil in a conductive layer of the smartcard;
arranging a fingerprint sensor module, a microcontroller module and a contact plate in the smartcard, wherein one of the fingerprint sensor module and the microcontroller module comprises a diode and a switch of an inductive voltage boost converter; and
forming an electrical connection between the inductor, the diode and the switch of the inductive voltage boost converter.

12. The method according to claim 11, wherein forming an inductor comprises arranging an isolated conductive wire in a coil pattern on the substrate of the smartcard.

13. The method according to claim 11, wherein forming an inductor comprises depositing a conductive foil in a coil pattern on the substrate of the smartcard.

14. The method according to claim 13, further comprising forming a second conductive layer and forming an electrical connection between an end portion termination of the coil and the second conductive layer.

15. The method according to claim 11, wherein forming the inductor comprises:
forming a first inductive coil in a first conductive layer of the smartcard;
forming a second inductive coil in a second conductive layer of the smartcard; and
connecting the first inductive coil in series with the second inductive coil.
